(19) United States
(12) Patent Application Publication
(10) Pub. No.: US 2024/0335269 A1
(43) Pub. Date: Oct. 10, 2024

(54) CROWN APPEARANCE COLOR CONFIRMING METHOD, INSTRUMENT KIT, AND DEMONSTRATION INSTRUMENT

(71) Applicant: Tokuyama Dental Corporation, Tokyo (JP)

(72) Inventors: Yuko NAGASAWA, Tokyo (JP); Hidenori MIMAKI, Tokyo (JP)

(21) Appl. No.: 18/294,073

(22) PCT Filed: Aug. 22, 2022
(86) PCT No.: PCT/JP2022/031526

§ 371 Date: Jan. 31, 2024

(30) Foreign Application Priority Data
Sep. 6, 2021 (JP) 2021-144884

(51) Int. Cl. A61C 19/10; A61C 5/77

(52) U.S. Cl. CPC A61C 19/10; A61C 5/77

(57) ABSTRACT

[Object] Provided is a method of previously confirming an appearance color of a crown after mounted on an abutment tooth of a patient, the crown being manufactured by CAD/CAM using a milling block made of a non-metal material and having a specific surface color pattern.

[Solving Means] Using an instrument kit or demonstration instrument including a crown sample and an abutment tooth sample, the crown sample being manufactured by CAD/CAM using a milling block substantially identical to a milling block to be used for manufacturing the crown and including an open cavity, the abutment tooth sample including an abutment tooth portion having a shape and a size with which the abutment tooth portion can be freely inserted into the open cavity, and having a surface color pattern substantially identical to a color of an abutment tooth of a patient, an appearance color of the crown sample is confirmed before and after the abutment tooth portion is inserted into the open cavity.

### TECHNICAL FIELD

The present invention relates to a crown appearance color confirming method of confirming a color tone of a tooth crown (crown) having a predetermined appearance color, the crown being a kind of a dental prosthesis made of a non-metal material such as a hybrid resin, when the crown is actually mounted onto an abutment tooth of a patient, an instrument kit that can be suitably used for the method, a demonstration instrument including the instrument kit, and the like.

### BACKGROUND ART

Dental prostheses used for dental treatment are generally formed by casting a metal material such as gold, silver, titanium, or a palladium alloy, formed by processing a non-metal material such as ceramics or a hybrid resin, or formed by making a core portion from a metal material and making a superficial layer portion such as a facing portion from a non-metal material. Note that a hybrid resin (hereinafter, abbreviated as “HR” in some cases) means a composite material in which inorganic infill (hereinafter, also referred to as “inorganic filler”) is dispersed in a resin matrix at a high density. Usually, the hybrid resin is obtained by polymerizing and curing a paste-like polymerizable curable composition containing a polymerizable monomer, an inorganic filler, and a polymerization initiator by pressurizing, heating, and the like.

Dental prostheses entirely formed of a non-metal material have advantages of eliminating a concern about metal allergy and being excellent in aesthetics, and additionally, have been easily processed due to the recent development of digital image technologies or computer processing technologies. Thus, the demand for the dental prostheses has been rapidly increasing. For example, as disclosed in Patent Literature 1, a computer-aided design (CAD)/computer-aided manufacturing (CAM) system has been widely used, in which a CAD/CAM apparatus based on the CAD and CAM technologies is used to perform cutting processing on a “CAD/CAM milling block” (also referred to as a dental processing blank in some cases) made of a non-metal material and to form a dental prosthesis on the basis of a captured image of an oral cavity. Here, the CAD/CAM milling block means a cut body (also referred to as a milling blank) that is attachable to a cutting machine in the CAD/CAM system, and usually includes a cut portion and a holding portion for enabling the cut portion to be attached to a cutting machine. As the cut portion, a (solid) block formed into a rectangular parallelepiped shape or columnar shape, a (solid) disk formed into a plate-like or disc-like shape, and the like are generally known. A milling blank including a cut portion made of a hybrid resin (hereinafter, a CAD/CAM milling block made of HR will also be simply referred to as “HR milling block”) is also known.

Incidentally, in order to achieve highly aesthetic restoration, it is necessary to determine the color (specified by hue, brightness, and saturation, that is, hue and color tone) of a tooth to be restored (restored tooth) or the color of surrounding teeth (such color determination is referred to as “shade taking” in some cases), select an HR milling block including a cut portion having a color that matches the determined color, and perform the restoration. Note that the shade taking is generally performed using a color tone sample for teeth, which is called a shade guide. There are various shade guides in which the number of color samples, the configuration of a holding instrument that holds the color samples, and the like are designed to facilitate color determination. Among them, “VITA Classical” (trade name) manufactured by VITA, which includes samples of total of 16 colors (a color specified by an index including a combination of hue and a mixed index of brightness and saturation or by an index considering hue, brightness, and saturation will also be referred to as “shade”) and is capable of determining the color of a site to be restored by comparing the shade guide with the colors of the site to be restored and surrounding teeth, is the most prevalent (See Patent Literature 1). Further, in addition to the above, a plurality of types of white tones, which are called bleach shades and simulate a state after whitening, are also used in some cases.

Note that, in the VITA shade guide, the colors of A to D systems are classified according to brightness and are represented by marks. In other words, the colors are classified into the A system (red brown), the B system (red yellow), the C system (ash), and the D system (red ash), and when 16 shades are arranged in the order of brightness (high to low in brightness), the following order is obtained: “B1→A1→B2→D2→A2→C1→C2→D4→A3→D3→B3→A3.5→B4→C3→A4→C4”.

HR blanks include a single-color blank including a cut portion made of a single HR layer (hereinafter, also referred to as “single-layer HR milling block”), and a blank including a plurality of HR layers having different colors (hereinafter, also referred to as “laminated HR milling block”). In each case, some shades selected from among the 16 shades described above are often prepared as basic shades (by the number of basic shades). In other words, in the single-layer HR milling block, the surface color pattern of the cut portion of the HR milling block has a specific single basic shade (color) on the entire surface, or in the laminated HR milling block, the surface color pattern of the cut portion of the HR milling block has a specific basic shade in one of the layers constituting the laminate and a shade other than the basic shade and/or colors other than the 16 shades in the other layers. As a result, colors are separated by a plurality of specific colors different from each other depending on the layer structure.

If the shade taking is performed and a milling block having a harmonizing shade is selected, restoration (treatment) with less discomfort can also be performed using a crown manufactured from the single-layer HR milling block. However, if highly aesthetic restoration is performed so as to faithfully reproduce a change in color at each site of a tooth, restoration (treatment) is favorably performed using a crown manufactured from the laminated HR milling block.

As the laminated HR milling block as described above, for example, Patent Literature 2 discloses the following dental prosthesis processing block: excellent in an aesthetic effect; excellent in mechanical strength without performing special processing such as coating processing; stably usable for a long period of time; excellent in processability such as cutting or grinding; having no bubbles left in the block; rigidly bonding resin layers to each other without involving a pressurizing step when the block is formed by superimposing a plurality of resin layers; having a color tone close to a natural color and including a further improved aesthetic effect; having a gradation in the color tone. Further, as a dental CAD/CAM cutting block that is excellent in general-purpose versatility and productivity and also has high reproducibility of the beauty of a natural tooth, Patent Literature 3 discloses a dental CAD/CAM cutting block that is a dental CAD/CAM resin-based block in which a dentin-restoring resin layer and an enamel-restoring resin layer are laminated, and at least the dentin-restoring resin layer contains light-diffusing particles and has a contrast ratio and a diffusion ratio that are adjusted in respective specific ranges. Further, Patent Literature 4 discloses a laminated milling blank that has high aesthetics and high mechanical strength.

Further, examples of a CAD/CAM milling block other than the HR milling block including a cut portion made of a non-metal material include a so-called zirconia dental processing blank. Usually, such a milling block includes a single layer and is used by being selected from milling blocks having a plurality of shades by shade taking. This holds true for the single-layer HR milling block.

### CITATION LIST

### Patent Literature

Patent Literature 1: Japanese Patent No. 6004769
Patent Literature 2: WO 2009/154301
Patent Literature 3: Japanese Patent Application Laid-open No. 2017-213394
Patent Literature 4: Japanese Patent Application Laid-open No. 2017-113224

### DISCLOSURE OF INVENTION

### Technical Problem

When a dentist performs treatment on a patient by using a crown that is a tooth crown prosthesis including a cavity into which an abutment tooth is to be inserted, if selection by shade taking using the CAD/CAM milling block (dental processing blank) made of a non-metal material is performed, the selection is usually performed on the basis of an appearance color of the CAD/CAM milling block before subjected to cutting processing. However, an appearance color tone of the crown when viewed alone and an appearance color tone of the crown when mounted on the abutment tooth of the patient are different from each other in many cases. When the crown manufactured from the selected CAD/CAM milling block is actually mounted onto the patient's abutment tooth (tooth in the form obtained by cutting/forming a tooth to be treated so as to match the crown), a desired color tone harmony is not obtained relatively in many cases.

In this regard, the present invention aims at providing a method of previously confirming an appearance color of a crown after mounted onto an abutment tooth of a patient, the crown being manufactured by CAD/CAM using a milling block made of a non-metal material and having a specific surface color pattern, an instrument kit suitably used for the method, and the like.

### Solution to Problem

The present invention is to solve the above problems, and a first form of the present invention is a crown appearance color confirming method of previously confirming an appearance color of a crown after an abutment tooth of a patient is inserted into an open cavity, the crown being a tooth crown prosthesis including the open cavity and being formed by computer-aided design (CAD)/computer-aided manufacturing (CAM) using a milling block, the crown appearance color confirming method including: preparing an instrument kit including a combination of an abutment tooth sample and a crown sample, the abutment tooth sample including an abutment tooth portion that has a surface color pattern substantially identical to a surface color pattern of the abutment tooth and is formed into a standard shape of the abutment tooth, the crown sample having a surface color pattern substantially identical to a surface color pattern of the crown, being formed into a standard shape of the crown by the CAD/CAM using a milling block substantially identical to a milling block to be used for forming the crown, and including an open cavity corresponding to the abutment tooth portion of the abutment tooth sample; and confirming an appearance color of the crown sample before and after the abutment tooth portion of the abutment tooth sample is inserted into the open cavity of the crown sample.

In the confirming step, an image or image data obtained by imaging an appearance of the crown sample may be used, the image or image data being obtained before and after the abutment tooth portion of the abutment tooth sample is inserted into the open cavity of the crown sample.

A second form of the present invention is an instrument kit including: at least one abutment tooth sample that is configured as an exemplar of an abutment tooth of a patient and includes an abutment tooth portion formed into a standard shape of the abutment tooth; and at least one crown sample that is configured as an exemplar of a crown, the crown being a tooth crown prosthesis including an open cavity into which the abutment tooth is to be inserted, the at least one crown sample being formed into a standard shape of the crown and including an open cavity corresponding to the abutment tooth portion of the abutment tooth sample, in which the instrument kit includes at least one of a plurality of abutment tooth samples or a plurality of crown samples, the plurality of abutment tooth samples constitutes at least one of a first abutment tooth sample group or a second abutment tooth sample group, the first abutment tooth sample group including the abutment tooth portions having shapes substantially identical to each other and having surface color patterns different from each other, the second abutment tooth sample group including the abutment tooth portions having surface color patterns substantially identical to each other and having shapes different from each other, and the plurality of crown samples constitutes at least one of a first crown sample group or a second crown sample group, the first crown sample group including the crown samples having shapes substantially identical to each other and having surface color patterns different from each other, the second crown sample group including the crown samples having surface color patterns substantially identical to each other and having shapes different from each other.

The surface color patterns of the at least one abutment tooth sample and the at least one crown sample may be configured using a plurality of colors including a color corresponding to one selected from 18 shades representing a color of a tooth.

The at least one crown sample may be formed by the CAD/CAM using a milling block that is made of a hybrid resin or ceramics.

In the instrument kit, the at least one abutment tooth sample may further include a pinch portion that extends from the abutment tooth portion to an opposite side in a direction of insertion into the open cavity.

The instrument kit is used for previously confirming an appearance color of the crown after the crown is mounted onto the abutment tooth of the patient, the crown being formed by the CAD/CAM using a milling block substantially identical to a milling block used for forming the crown sample.

The instrument kit may include the first abutment tooth sample group and the first crown sample group, and the shapes of the abutment tooth portions of the plurality of abutment tooth samples constituting the first abutment tooth sample group may coincide with the shapes of the open cavities of the plurality of crown samples constituting the first crown sample group on a one-to-one basis.

The instrument kit may include the second abutment tooth sample group and the second crown sample group, and the plurality of crown samples constituting the second crown sample group may include crown samples including the open cavities having shapes corresponding to all the shapes of the abutment tooth portions of the plurality of abutment tooth samples constituting the second abutment tooth sample group.

A third form of the present invention is a demonstration instrument used for demonstrating the crown appearance color confirming method, the demonstration instrument including the instrument kit, in which the number of the plurality of crown samples is 2 to 18, and the plurality of crown samples are each arranged in a state capable of receiving insertion of the abutment tooth portion of the abutment tooth sample into the open cavity.

A fourth form of the present invention is a method of adopting a milling block to be used for forming a crown by computer-aided design (CAD)/computer-aided manufacturing (CAM), the crown being a tooth crown prosthesis including an open cavity, the method including: preparing the instrument kit; selecting, from the first abutment tooth sample group, an abutment tooth sample including an abutment tooth portion having a shape and a surface color pattern that are similar to a shape and a surface color pattern of an abutment tooth of a patient; confirming an appearance color after the abutment tooth portion of the abutment tooth sample selected in the selecting step is inserted into the open cavity, for each of the plurality of crown samples constituting the first crown sample group; and determining, from the plurality of crown samples constituting the first crown sample group, a crown sample having the appearance color confirmed in the confirming step that best matches an appearance color of the tooth of the patient, and adopting a milling block that is substantially identical to a milling block used for forming the determined crown sample.

In the confirming step, an image or image data obtained by imaging appearances of the plurality of crown samples may be used, the image or image data being obtained before and after the abutment tooth portion of the abutment tooth sample is inserted into the open cavity of each of the plurality of crown samples.

A fifth form of the present invention is a confirming method for an influence of a shape of an abutment tooth on an appearance color of a crown formed using a candidate milling block in adopting a milling block to be used for forming a crown by computer-aided design (CAD)/computer-aided manufacturing (CAM), the crown being a tooth crown prosthesis including an open cavity into which the abutment tooth is to be inserted, in a stage in which a surface color pattern of a abutment tooth of a patient has been confirmed but a shape of the abutment tooth of the patient is undetermined, the method including: preparing the instrument kit, in which the surface color patterns of the abutment tooth portions of the plurality of abutment tooth samples constituting the second abutment tooth sample group are substantially identical to or similar to a surface color pattern of the abutment tooth, and the plurality of crown samples constituting the second crown sample group are each formed using a milling block substantially identical to the candidate milling block; and confirming the appearance color after the abutment tooth portion of the abutment tooth sample is inserted into the open cavity, for each of combinations of the crown sample and the abutment tooth sample respectively including the open cavity and the abutment tooth portion having shapes corresponding to each other and respectively selected from the second crown sample group and the second abutment tooth sample group.

In the confirming step, an image or image data obtained by imaging an appearance of the crown sample may be used, the image or image data being obtained before and after the abutment tooth portion of the abutment tooth sample is inserted into the open cavity of the crown sample.

### Advantageous Effects of Invention

According to the crown appearance color confirming method of the present invention, for example, using an abutment tooth sample including an abutment tooth portion having a shade (color) determined by performing shade taking for a color of an abutment tooth of a patient, the abutment tooth portion is inserted into an open cavity of a crown sample to previously confirm an appearance color thereof, so that compatibility of the color tone of a crown at the time of treatment can be confirmed, the crown being manufactured by CAD/CAM using a milling block substantially identical to a milling block used for manufacturing the crown sample. Therefore, it is possible to adopt a milling block to be used by CAD/CAM after expecting an actual finished state.

### BRIEF DESCRIPTION OF DRAWINGS

FIG. 1 shows a front view, a plan view, a bottom view, a right-side view, and a longitudinal sectional view of a representative crown sample in an instrument kit of the present invention.

FIG. 2 shows right-side views of two types of representative abutment tooth samples in the instrument kit of the present invention.

FIG. 3 is a photograph of a demonstration instrument according to one embodiment of the present invention.

FIG. 4 is a photograph showing a state in which an abutment tooth portion of the abutment tooth sample is inserted into an open cavity of the crown sample in the demonstration instrument shown in FIG. 3.

FIG. 5 is a photograph showing a first abutment tooth sample group that is suitably used in the demonstration instrument of the present invention.

FIG. 6 is a photograph showing a demonstration instrument according to another embodiment of the present invention.

### MODE(S) FOR CARRYING OUT THE INVENTION

The inventors of the present invention have considered the following reasons why a desired color tone harmony cannot be obtained at the time of mounting a crown irrespective of the fact that the crown is manufactured by CAD/CAM using a milling block selected by previously performing shade taking: (1) how an appearance color is seen is affected by the thickness of a material; and (2) a non-metal material has a certain degree of transparency even if it is colored, and thus if the material is thin, the color of a base is seen through the material and the appearance color is changed. If a crown sample processed into a shape equivalent to an actual crown is mounted onto an abutment tooth sample having a color equivalent to an actual color of an abutment tooth of a patient, and the appearance color of the crown sample is confirmed, evaluation of the appearance color can be reliably performed when restoration (treatment) is performed using an actual crown. On the basis of such an idea, the inventors of the present invention have studied a method for simply and reliably performing such a confirmation. The present invention have been made as a result of such studies.

A milling block to be evaluated is not particularly limited as long as it includes a cut portion made of a non-metal material. From the viewpoint of effectiveness, a milling block made of a hybrid resin (HR) or ceramics such as zirconia is suitable. In particular, from the viewpoint of allowing highly aesthetic restoration, a laminated HR milling block is particularly suitable, and an E-M-D laminated HR milling block in which an enamel layer E, a middle HR layer M, and a dentin layer D are laminated is the most favorable. Here, the enamel layer E means an HR layer having a color corresponding to an appearance color of an enamel portion in which dentin is not present in the base. The dentin layer D means an HR layer having a color corresponding to an appearance color of the enamel portion in a portion in which dentin is present in the base. The middle HR layer M means an HR layer having an intermediate color between the colors of the enamel layer E and the dentin layer D. Note that the middle HR layer M usually includes one to three layers. If the middle HR layer M includes two layers or three layers, it is favorable that the middle HR layers M have colors different from each other and are laminated layers having gradations of color.

Further, the crown to be the target of the present invention may be used for any one of an anterior tooth, a canine tooth, a bicuspid tooth, and a molar tooth, but it is favorably a crown for the anterior tooth from the viewpoint that highly aesthetic restoration is required and an effect of the present invention is highly exhibited.

A crown appearance color confirming method of the present invention includes a preparing step and a confirming step. In the preparing step, an instrument kit 1 of the present invention or a demonstration instrument 30 of the present invention is prepared. The crown appearance color confirming method of the present invention may also be referred to as a using form of the instrument kit 1 of the present invention or the demonstration instrument 30 of the present invention. Further, the demonstration instrument 30 of the present invention includes the instrument kit 1 of the present invention. The instrument kit 1 includes a combination of an abutment tooth sample 20 and a crown sample 10, as instruments constituting the instrument kit 1. The abutment tooth sample 20 includes an abutment tooth portion 21 that has a surface color pattern substantially identical to that of an abutment tooth of a patient and is formed into a standard shape of the abutment tooth. The crown sample 10 has a surface color pattern substantially identical to that of a crown, is formed into a standard shape of the crown by CAD/CAM using a milling block substantially identical to a milling block to be used for forming the crown, and includes an open cavity 11 corresponding to the abutment tooth portion 21 of the abutment tooth sample 20. Here, in the present invention, the wording “substantially identical” means a configuration obtained on the basis of a design intended to be identical, and a configuration in which only a difference of a degree that is unavoidable in the manufacturing process is present is also included in “substantially identical”. In the confirming step, an appearance color of the crown sample 10 is confirmed before and after the abutment tooth portion 21 of the abutment tooth sample 20 is inserted into the open cavity 11 of the crown sample 10 constituting the instrument kit 1. The crown appearance color confirming method of the present invention can be configured as a real confirming method of visually confirming the appearance color of the crown sample 10 in the confirming step or as an image confirming method using an image or image data obtained by imaging the appearance of the crown sample 10 before and after the abutment tooth portion 21 of the abutment tooth sample 20 is inserted into the open cavity 11 of the crown sample 10 in the confirming step. In the image confirming method, a catalog photograph, a moving image, or the like showing the outer appearance of the crown sample 10 can also be used as the image or image data. As described above, in the crown appearance color confirming method of the present invention, it is possible to previously confirm an appearance color of a crown after mounted onto a abutment tooth of a patient, the crown being formed by CAD/CAM using a milling block substantially identical to a milling block used for forming the crown sample 10. Hereinafter, the instrument kit 1 of the present invention and the crown appearance color confirming method of the present invention will be described together with the description of the demonstration instrument 30 of the present invention with reference to the drawings, exemplifying a case where an appearance color of a crown for an anterior tooth after mounted is previously confirmed, the crown being manufactured from an E-M-D laminated HR milling block.

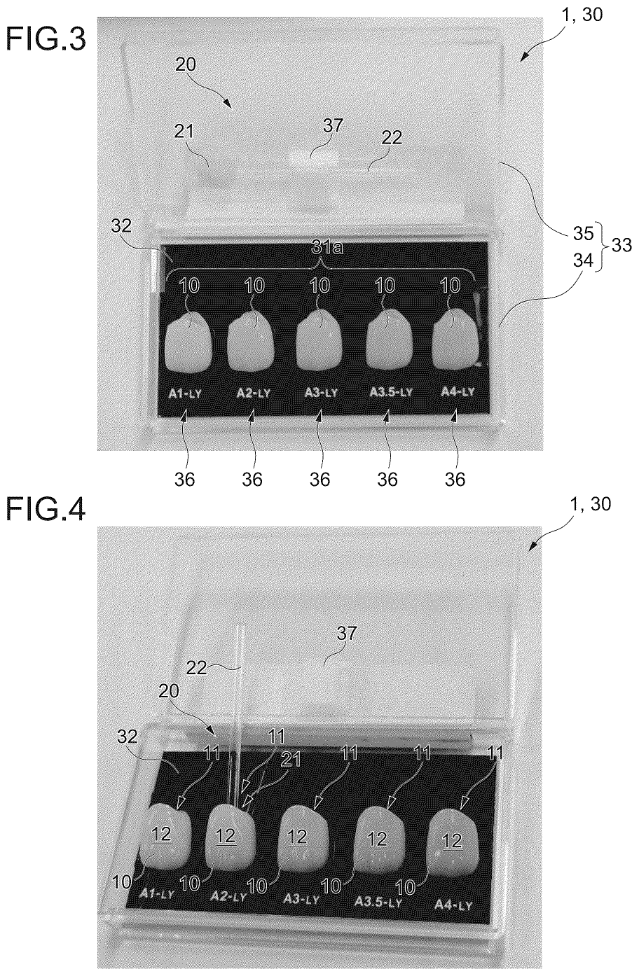

The demonstration instrument 30 shown in FIGS. 3 and 4 (which are both photographs) is a representative form of the demonstration instrument 30 of the present invention, and includes an instrument kit 1, a plate 32, and a case 33. The instrument kit 1 of the present invention includes a combination of at least one crown sample 10 and at least one abutment tooth sample 20. The instrument kit 1 shown in FIGS. 3 and 4 includes a first crown sample group 31a including a plurality of crown samples 10 and a single abutment tooth sample 20. Specifically, the first crown sample group 31a includes five crown samples 10 having shapes substantially identical to each other and having surface color patterns different from each other.

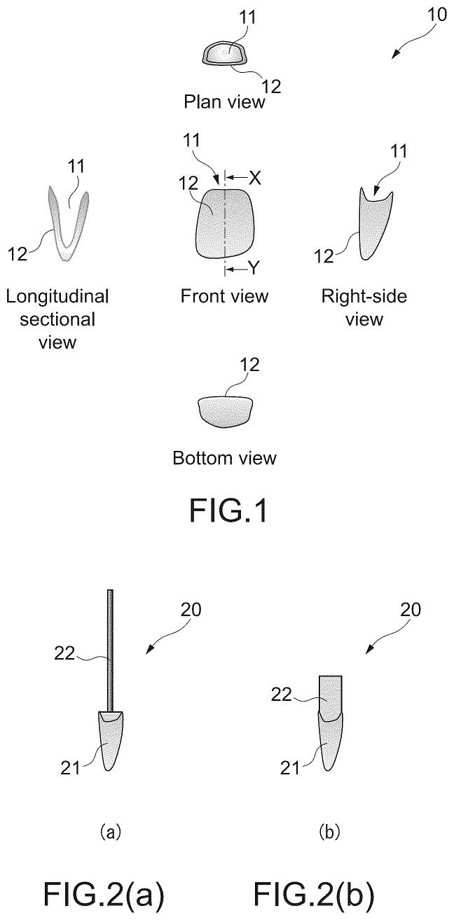

Here, the crown sample 10 is a sample processed into a standard shape of a crown, which is a tooth crown prosthesis used for inserting an abutment tooth into an open cavity thereof, and is configured as an exemplar of the crown. The crown sample 10 includes an open cavity 11 corresponding to the open cavity of the crown. FIG. 1 shows a front view, a plan view, a bottom view, a right-side view, and a longitudinal sectional view of a representative crown sample 10. In FIG. 1, the longitudinal sectional view shows a cross-section of the crown sample 10 along the XY line in the front view. In the crown sample 10, the open cavity 11 is configured as a cavity that is opened upward and closed laterally and downward. Further, the crown sample 10 has a surface 12 that is turned to the front when mounted onto an abutment tooth of a patient. Note that the crown sample 10 may be provided with, for example, a retaining unit as a pedestal for holding the crown sample 10 on the plate 32 in a predetermined state.

The crown sample 10 is usually manufactured by CAD/CAM using a milling block made of a non-metal material, and thus has a surface color pattern that reflects the color pattern of the milling block used. Here, in the present invention, the surface color pattern means a pattern of the appearance color of the surface and means a surface color pattern in a case where the entire color is a single color and a case where colors are separated by a plurality of specific different colors.

In other words, the surface color pattern means the arrangement of colors on the surface, specifically, a colored pattern indicating which color occupies which portion of the surface if a plurality of colors are used, and includes a case where the entire surface has a single color. The surface color pattern of the crown sample 10 is favorably configured using a plurality of colors including a color corresponding to one selected from among 18 shades representing the color of a tooth.

Further, (a) and (b) of FIG. 2 respectively show right-side views of two types of representative abutment tooth samples 20. The abutment tooth sample 20 includes an abutment tooth portion 21 that is formed into a standard shape of an abutment tooth of a patient and configured as an exemplar of an abutment tooth made of an artificial material. The abutment tooth portion 21 has a shape and a size, which correspond to those of the open cavity 11 of the crown sample 10 and with which the abutment tooth portion 21 can be freely inserted into the open cavity 11, and also has a surface color pattern substantially identical to the color of the abutment tooth. If the abutment tooth portion 21 having a surface color substantially identical to the color of the abutment tooth of the patient is used, the appearance color of a crown when mounted onto the abutment tooth of the patient can be previously confirmed. The surface color pattern of the abutment tooth portion 21 is favorably configured using a plurality of colors including a color corresponding to one selected from among 18 shades representing the color of a tooth. Further, the abutment tooth sample 20 favorably includes a pinch portion 22. The pinch portion 22 extends from the abutment tooth portion 21 to the opposite side in the direction of insertion into the open cavity 11 of the crown sample 10. The pinch portion 22 enhances convenience in operating the abutment tooth sample 20. For example, the abutment tooth sample 20 can be manually freely operated when the pinch portion 22 is pinched with fingers. The shape of the pinch portion 22 is not particularly limited as long as the object described above can be achieved. For example, in the abutment tooth sample 20 shown in (a) of FIG. 2, the pinch portion 22 provided as a rod-shaped member separately from the abutment tooth portion 21 is attached to the abutment tooth portion 21. In the abutment tooth sample 20 shown in (b) of FIG. 2, the pinch portion 22 is integrally formed with the abutment tooth portion 21 and is provided in a convex piece shape protruding from the abutment tooth portion 21.

As described above, if HR blanks are sold as commodities, in many cases, a plurality of types of HR blanks having the same standard and being different from each other only in surface color pattern are prepared, and a plurality of grades of different shades (surface color patterns) are prepared and sold as a series of commodities, so that the surface color pattern can be selected for purchase. The demonstration instrument 30 shown in FIGS. 3 and 4 includes the first crown sample group 31a including crown samples having shapes substantially identical to each other and surface color patterns different from each other, and thus is suitable as a tool for comparing the appearance colors of the HR blanks (when formed into crown and mounted) in each grade for the commodities as described above.

The instrument kit 1 shown in FIGS. 3 and 4 includes a combination of the first crown sample group 31a including the five crown samples 10 and the single abutment tooth sample 20. The five crown samples 10 include the respective open cavities 11 having shapes identical or substantially identical to each other and having surface color patterns different from each other. The five crown samples 10 shown in FIGS. 3 and 4 are each manufactured by using an E-M-D laminated HR milling block, in which the shades of the dentin layer D and the middle HR layer M are different from each other and the shades of the enamel layer E are identical to each other, so that the surface color patterns of the respective crown samples 10 also reflect such differences. Incidentally, the shades of the dentin layers D of the respective crown samples 10 are A1, A2, A3, A3.5, and A4 from the left side of the figure. Note that the number of crown samples 10 having the identical shape and different colors and constituting the first crown sample group 31a only needs to be 2 to 18 (note that the upper limit of 18 is obtained by adding the number of shades 2, which is called bleach shade and simulates whitening, to the number of VITA shades 16. Usually, comparison is often performed with the same system color or two system colors. In such cases, the number of crown samples 10 constituting the first crown sample group 31a is favorably 2 to 9, and particularly favorably 3 to 7.

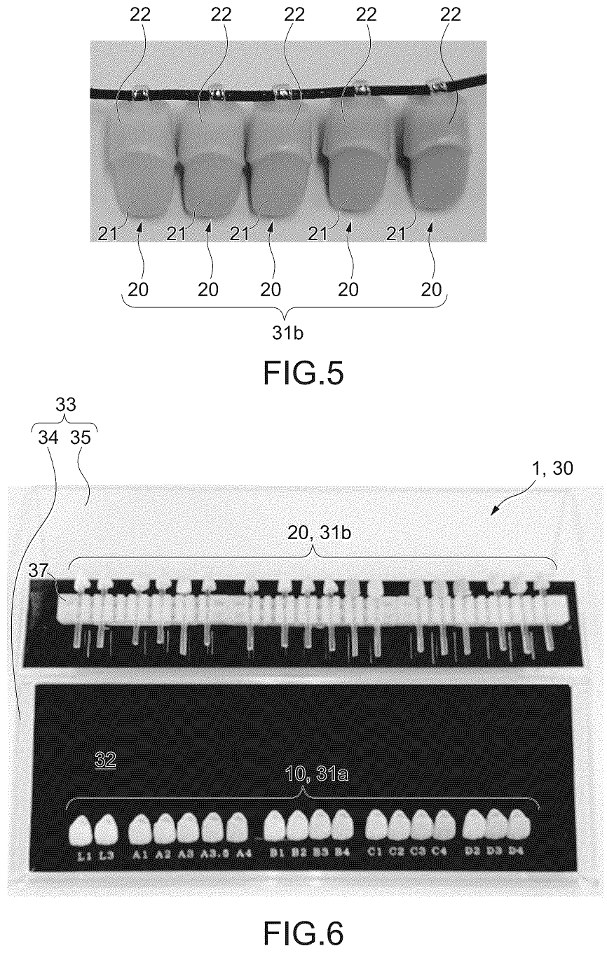

Further, the single abutment tooth sample 20 is used in the instrument kit 1 of the present invention in the mode shown in FIGS. 3 and 4, but a first abutment tooth sample group 31b including two or more abutment tooth samples 20 having sizes and shapes identical or substantially identical to each other and having surface color patterns different from each other may be used. FIG. 5 is a view illustrating the first abutment tooth sample group 31b by an example. In the first abutment tooth sample group 31b shown in FIG. 5, the shades of the five abutment tooth samples 20 are A1, A2, A3, A3.5, and A4 from the left side of the figure. The five abutment tooth samples 20 constituting the first abutment tooth sample group 31b shown in FIG. 5 each have the configuration shown in (b) of FIG. 2. Further, in the first abutment tooth sample group 31b shown in FIG. 5, the five abutment tooth samples 20 are collectively held by a single string that passes through ring-shaped hook portions provided to the respective pinch portions 22.

Further, the plate 32 included in the demonstration instrument 30 functions as a mount for holding the crown samples 10 disposed side by side. The material of the plate 32 is not particularly limited, and hard paper, a synthetic resin such as polyethylene, polypropylene, acrylonitrile butadiene styrene (ABS resin), or polycarbonate, or a metal such as a stainless steel plate can be used. However, materials formed of a synthetic resin such as polypropylene are favorable because of easy processing, light weight, and no corrosion. Further, it is not necessarily required to be a plate-like member having high rigidity, and it may be a sheet-like member having flexibility. In the case of such a sheet-like member, it is favorably used by being laid in a rigid case 33 or the like. On the display surface, which is the main surface of the plate 32, the crown samples 10 are arranged and fixedly held in a state in which each crown sample 10 can receive insertion of the abutment tooth portion 21 of the abutment tooth sample 20 into the open cavity 11 without changing the posture. Specifically, the crown samples 10 are disposed and fixed with the respective open cavities 11 being opened upward in a manner that an appearance color of each crown sample 10 before and after the abutment tooth sample 20 is inserted is easily confirmed, that the front surface 12 on the front side of the crown sample 10 faces the front and the back surface thereof faces the display surface of the plate 32, and that the abutment tooth sample 20 can be freely (forward and backward) inserted into the open cavity 11 of the crown sample 10. The color of the plate 32 is not particularly limited, but it is favorably black or a dark color other than black in order to express the state of a color in the oral cavity.

The size of the plate 32 is appropriately determined according to the number of crown samples 10 to be held and an arrangement form thereof, and is usually 2 to 10 cm in length, 2 to 15 cm in width, and 0.1 to 5 mm in thickness, favorably 2.5 to 6 cm in length, 2.5 to 8 cm in width, and 0.3 to 2 mm in thickness. Further, it is favorable that the display surface of the plate 32 is provided with a caption display portion 36 for displaying information regarding the crown sample 10 to be held (for example, information for specifying the milling block used for manufacturing the crown sample by CAD/CAM, specifically, a trade name, a grade, a model number, and the like).

Holding the crown samples 10 on the display surface of the plate 32 is usually performed by bonding with an adhesive, but can also be performed by using holding means for detachably holding the crown samples 10. Use of such holding means makes it possible to appropriately replace the crown samples 10 to be compared with each other and hold the crown samples 10 on one plate 32. This is convenient when the comparison and confirmation are performed from various viewpoints within a short time. Usually, such holding means may be configured in a manner that holding means installed on the display surface of the plate 32 (one holding means) and holding means installed in the crown sample 10 (another holding means) are detachably provided as a set. Examples of the holding means include an adhesive tape, a hook-and-loop fastener, a snap button, and various one-touch connectors or one-touch joints.

For example, since the crown sample 10 is manufactured by CAD/CAM using a milling block to be a commodity and thus the color tone compatibility obtained when a crown manufactured from the commodity is actually mounted can be shown in demonstration, the demonstration instrument 30 according to this embodiment is useful as an advertisement tool or a sales promotion tool for the commodity. When the demonstration instrument 30 is used in such an application, it is favorable that the plate 32 holding the crown samples 10 and the abutment tooth sample 20 are housed in a dedicated case 33 as shown in FIG. 3. In the demonstration instrument 30 shown in FIG. 3, the case 33 has a configuration in which a case main body 34 and a lid portion 35 are connected to each other by a hinge so as to be openable and closable. In the case 33, a holding mechanism 37 for holding the abutment tooth sample 20 is provided inside the lid portion 35, and the plate 32 holding the crown samples 10 is housed in the case main body 34. As shown in FIG. 4, in the demonstration instrument 30, it is possible to insert the abutment tooth portion 21 of the abutment tooth sample 20 into the open cavity 11 of the crown sample 10 by pinching the pinch portion 22 with the lid portion 35 being opened (without taking out the plate 32). Note that in FIG. 4 the appearance color of the second crown sample 10 from the left, “A2-LY”, (indicating that it is manufactured from an E-M-D laminated HR milling block in which the shade of D is A2) is changed to be slightly reddish after the abutment tooth portion 21 of the abutment tooth sample 20 is inserted, in comparison with the appearance color before the insertion.

The instrument kit 1 including the first crown sample group 31a including the five crown samples 10 and the single abutment tooth sample 20 has been described above, but the instrument kit 1 of the present invention is not limited thereto. For example, the abutment tooth sample 20 is prepared not as the single abutment tooth sample 20 but as the first abutment tooth sample group 31b in which the shapes of the abutment tooth portions 21 are substantially identical to each other and the surface color patterns of the abutment tooth portions 21 are different from each other as shown in FIG. 5, so that it is possible to confirm the appearance color when the crown is mounted onto the abutment tooth having various colors. Of course, the abutment tooth sample 20 constituting the first abutment tooth sample group 31b is not limited to have the configuration shown in (b) of FIG. 2 and may have the configuration shown in (a) of FIG. 2.

The instrument kit 1 constituting the demonstration instrument 30 shown in FIG. 6 uses the abutment tooth samples 20 each having the configuration shown in (a) of FIG. 2, in which 18 crown samples 10 having surface color patterns different from each other are set as the first crown sample group 31a, and further 18 abutment tooth samples 20 corresponding to the color tones of the respective crown samples 10 are set as the first abutment tooth sample group 31b in the dedicated case 33. As in the demonstration instrument 30 shown in FIG. 6, a large number of color tones are displayed as the crown samples 10 in the case main body 34 at a time, so that an operator can select the most suitable color tone for a patient. Further, the abutment tooth sample 20 corresponding to each color tone is held inside the lid portion 35, which makes it possible to select an exact color tone in a short time while taking into consideration the color tone of the abutment tooth of the patient. At that time, since it is possible to confirm a combination of different color tones between the crown and the abutment tooth, it is possible to smoothly cope with a patient's need for treatment using a whiter crown, for example. In the instrument kit 1 including the first crown sample group 31a and the first abutment tooth sample group 31b as shown in FIG. 6, it is favorable that the shapes of the open cavities 11 of the plurality of crown samples 10 constituting the first crown sample group 31a coincide with the shapes of the abutment tooth portions 21 of the plurality of abutment tooth samples 20 constituting the first abutment tooth sample group 31b on a one-to-one basis.

Further, the instrument kit 1 of the present invention may be configured to include a second crown sample group including a plurality of crown samples 10 having surface color patterns substantially identical to each other and having shapes different from each other, instead of the first crown sample group 31a or in addition to the first crown sample group 31a. Furthermore, the instrument kit 1 of the present invention may be configured to include a second abutment tooth sample group including a plurality of abutment tooth samples 20 in which abutment tooth portions 21 have surface color patterns substantially identical to each other and shapes different from each other, instead of the first abutment tooth sample group 31b or in addition to the first abutment tooth sample group 31b. In this case, the instrument kit 1 of the present invention can also have a mode in which the number of crown samples 10 constituting the second crown sample group and the number of abutment tooth samples 20 constituting the second abutment tooth sample group are set to be identical, and the shapes and sizes of the abutment tooth portions 21 of the plurality of abutment tooth samples 20 constituting the second abutment tooth sample group coincide with the shapes and sizes of the open cavities 11 of the plurality of crown samples 10 constituting the second crown sample group on a one-to-one basis. In other words, such an instrument kit 1 can also have a mode in which the plurality of crown samples 10 constituting the second crown sample group includes crown samples 10 including open cavities 11 having shapes corresponding to all the shapes of the abutment tooth portions 21 of the plurality of abutment tooth samples 20 constituting the second abutment tooth sample group. Use of the instrument kit 1 having such a mode makes it possible to know the influence of those factors on the appearance color at the time of mounting, for example, when crowns having different shapes or different thicknesses are manufactured from one type of HR milling block.

Furthermore, it is possible to provide a method of adopting a milling block to be used for forming a crown, which is a tooth crown prosthesis including an open cavity, by CAD/CAM using the instrument kit 1 of the present invention or the demonstration instrument 30 of the present invention. The method of adopting a milling block of the present invention includes a preparing step, a selecting step, a confirming step, and an adopting step. In the preparing step, the instrument kit 1 or demonstration instrument 30 that includes the first crown sample group 31a and the first abutment tooth sample group 31b is prepared. In the selecting step, an abutment tooth sample 20 including an abutment tooth portion 21 having a shape and a surface color pattern that are similar to those of an abutment tooth of a patient is selected from the first abutment tooth sample group 31b. In the confirming step, an appearance color is confirmed after the abutment tooth portion 21 of the abutment tooth sample 20 selected in the selecting step is inserted into the open cavity 11, for each of the plurality of crown samples 10 constituting the first crown sample group 31a. In the confirming step, for example, an image or image data obtained by imaging appearances of the plurality of crown samples 10 can be used, the image or image data being obtained before and after the abutment tooth portion 21 of the abutment tooth sample 20 is inserted into the open cavity 11 of each of the plurality of crown samples 10. In the adopting step, a crown sample 10 having the appearance color confirmed in the confirming step that best matches an appearance color of the tooth of the patient is determined from the plurality of crown samples 10 constituting the first crown sample group 31a, and a milling block that is substantially identical to a milling block used for forming the determined crown sample is adopted.

In addition, use of the instrument kit 1 of the present invention or the demonstration instrument 30 of the present invention makes it possible to provide a confirming method for an influence of a shape of an abutment tooth on an appearance color of a crown formed using a candidate milling block in adopting a milling block to be used for forming a crown by CAD/CAM, the crown being a tooth crown prosthesis including an open cavity into which the abutment tooth is to be inserted, in a stage in which a surface color pattern of a abutment tooth of a patient has been confirmed but a shape of the abutment tooth of the patient is undetermined. The confirming method of the present invention includes a preparing step and a confirming step. In the preparing step, the instrument kit 1 or demonstration instrument 30 including a second crown sample group and a second abutment tooth sample group is prepared, in which the surface color patterns of the abutment tooth portions 21 of the plurality of abutment tooth samples 20 constituting the second abutment tooth sample group are substantially identical to or similar to the surface color pattern of the abutment tooth, and the plurality of crown samples 10 constituting the second crown sample group are each formed using a milling block substantially identical to a candidate milling block. In the confirming step, the appearance color after the abutment tooth portion 21 of the abutment tooth sample 20 is inserted into the open cavity 11 is confirmed for each of combinations of the crown sample 10 and the abutment tooth sample 20, which respectively include the open cavity 11 and the abutment tooth portion 21 having shapes corresponding to each other and are respectively selected from the second crown sample group and the second abutment tooth sample group. In the confirming step, an image or image data obtained by imaging the appearances of the plurality of crown samples 10 can be used, the image or image data being obtained before and after the abutment tooth portion 21 of the abutment tooth sample 20 is inserted into the open cavity 11 of each of plurality of crown samples 10.

### REFERENCE SIGNS LIST

1 instrument kit
10 crown sample
11 open cavity
12 surface
20 abutment tooth sample
21 abutment tooth portion
22 pinch portion
30 demonstration instrument
31a first crown sample group
31b first abutment tooth sample group
32 plate
33 case
34 case main body
35 lid portion
36 caption display portion
37 holding mechanism

1. A crown appearance color confirming method of previously confirming an appearance color of a crown after an abutment tooth of a patient is inserted into an open cavity, the crown being a tooth crown prosthesis including the open cavity and being formed by computer-aided design (CAD)/computer-aided manufacturing (CAM) using a milling block, the crown appearance color confirming method comprising:
preparing an instrument kit including a combination of an abutment tooth sample and a crown sample,
the abutment tooth sample including an abutment tooth portion that has a surface color pattern substantially identical to a surface color pattern of the abutment tooth and is formed into a standard shape of the abutment tooth,
the crown sample having a surface color pattern substantially identical to a surface color pattern of the crown, being formed into a standard shape of the crown by the CAD/CAM using a milling block substantially identical to a milling block to be used for forming the crown, and including an open cavity corresponding to the abutment tooth portion of the abutment tooth sample; and
confirming an appearance color of the crown sample before and after the abutment tooth portion of the abutment tooth sample is inserted into the open cavity of the crown sample.

2. The crown appearance color confirming method according to claim 1, wherein
in the confirming step, an image or image data obtained by imaging an appearance of the crown sample is used, the image or image data being obtained before and after the abutment tooth portion of the abutment tooth sample is inserted into the open cavity of the crown sample.

3. An instrument kit, comprising:
at least one abutment tooth sample that is configured as an exemplar of an abutment tooth of a patient and includes an abutment tooth portion formed into a standard shape of the abutment tooth; and
at least one crown sample that is configured as an exemplar of a crown, the crown being a tooth crown prosthesis including an open cavity into which the abutment tooth is to be inserted, the at least one crown sample being formed into a standard shape of the crown and including an open cavity corresponding to the abutment tooth portion of the abutment tooth sample, wherein
the instrument kit includes at least one of a plurality of abutment tooth samples or a plurality of crown samples,
the plurality of abutment tooth samples constitutes at least one of a first abutment tooth sample group or a second abutment tooth sample group, the first abutment tooth sample group including the abutment tooth portions having shapes substantially identical to each other and having surface color patterns different from each other, the second abutment tooth sample group including the abutment tooth portions having surface color patterns substantially identical to each other and having shapes different from each other, and
the plurality of crown samples constitutes at least one of a first crown sample group or a second crown sample group, the first crown sample group including the crown samples having shapes substantially identical to each other and having surface color patterns different from each other, the second crown sample group including the crown samples having surface color patterns substantially identical to each other and having shapes different from each other.

4. The instrument kit according to claim 3, wherein
the surface color patterns of the at least one abutment tooth sample and the at least one crown sample are configured using a plurality of colors including a color corresponding to one selected from 18 shades representing a color of a tooth.

5. The instrument kit according to claim 3, wherein
the at least one crown sample is formed by the CAD/CAM using a milling block that is made of a hybrid resin or ceramics.

6. The instrument kit according to claim 3, wherein
the at least one abutment tooth sample further includes a pinch portion that extends from the abutment tooth portion to an opposite side in a direction of insertion into the open cavity.

7. The instrument kit according to claim 5, wherein
the instrument kit is used for previously confirming an appearance color of the crown after the crown is mounted onto the abutment tooth of the patient, the crown being formed by the CAD/CAM using a milling block substantially identical to a milling block used for forming the crown sample.

8. The instrument kit according to claim 3, wherein
the instrument kit includes the first abutment tooth sample group and the first crown sample group, and
the shapes of the abutment tooth portions of the plurality of abutment tooth samples constituting the first abutment tooth sample group coincide with the shapes of the open cavities of the plurality of crown samples constituting the first crown sample group on a one-to-one basis.

9. The instrument kit according to claim 3, wherein
the instrument kit includes the second abutment tooth sample group and the second crown sample group, and
the plurality of crown samples constituting the second crown sample group includes crown samples including the open cavities having shapes corresponding to all the shapes of the abutment tooth portions of the plurality of abutment tooth samples constituting the second abutment tooth sample group.

10. A demonstration instrument used for demonstrating the crown appearance color confirming method according to claim 1, the demonstration instrument comprising
an instrument kit, comprising:
at least one abutment tooth sample that is configured as an exemplar of an abutment tooth of a patient and includes an abutment tooth portion formed into a standard shape of the abutment tooth; and
at least one crown sample that is configured as an exemplar of a crown, the crown being a tooth crown prosthesis including an open cavity into which the abutment tooth is to be inserted, the at least one crown sample being formed into a standard shape of the crown and including an open cavity corresponding to the abutment tooth portion of the abutment tooth sample, wherein
the instrument kit includes at least one of a plurality of abutment tooth samples or a plurality of crown samples,
the plurality of abutment tooth samples constitutes at least one of a first abutment tooth sample group or a second abutment tooth sample group, the first abutment tooth sample group including the abutment tooth portions having shapes substantially identical to each other and having surface color patterns different from each other, the second abutment tooth sample group including the abutment tooth portions having surface color patterns substantially identical to each other and having shapes different from each other, and
the plurality of crown samples constitutes at least one of a first crown sample group or a second crown sample group, the first crown sample group including the crown samples having shapes substantially identical to each other and having surface color patterns different from each other, the second crown sample group including the crown samples having surface color patterns substantially identical to each other and having shapes different from each other: wherein
the number of the plurality of crown samples is 2 to 18, and
the plurality of crown samples are each arranged in a state capable of receiving insertion of the abutment tooth portion of the abutment tooth sample into the open cavity.

11. A method of adopting a milling block to be used for forming a crown by computer-aided design (CAD)/computer-aided manufacturing (CAM), the crown being a tooth crown prosthesis including an open cavity, the method comprising:
preparing the instrument kit according to claim 8;
selecting, from the first abutment tooth sample group, an abutment tooth sample including an abutment tooth portion having a shape and a surface color pattern that are similar to a shape and a surface color pattern of an abutment tooth of a patient;
confirming an appearance color after the abutment tooth portion of the abutment tooth sample selected in the selecting step is inserted into the open cavity, for each of the plurality of crown samples constituting the first crown sample group; and
determining, from the plurality of crown samples constituting the first crown sample group, a crown sample having the appearance color confirmed in the confirming step that best matches an appearance color of the tooth of the patient, and adopting a milling block that is substantially identical to a milling block used for forming the determined crown sample.

12. The method of adopting a milling block according to claim 11, wherein
in the confirming step, an image or image data obtained by imaging appearances of the plurality of crown samples is used, the image or image data being obtained before and after the abutment tooth portion of the abutment tooth sample is inserted into the open cavity of each of the plurality of crown samples.

13. A confirming method for an influence of a shape of an abutment tooth on an appearance color of a crown formed using a candidate milling block in adopting a milling block to be used for forming a crown by computer-aided design (CAD)/computer-aided manufacturing (CAM), the crown being a tooth crown prosthesis including an open cavity into which the abutment tooth is to be inserted, in a stage in which a surface color pattern of a abutment tooth of a patient has been confirmed but a shape of the abutment tooth of the patient is undetermined, the method comprising:
preparing the instrument kit according to claim 9, in which the surface color patterns of the abutment tooth portions of the plurality of abutment tooth samples constituting the second abutment tooth sample group are substantially identical to or similar to a surface color pattern of the abutment tooth, and the plurality of crown samples constituting the second crown sample group are each formed using a milling block substantially identical to the candidate milling block; and
confirming the appearance color after the abutment tooth portion of the abutment tooth sample is inserted into the open cavity, for each of combinations of the crown sample and the abutment tooth sample respectively including the open cavity and the abutment tooth portion having shapes corresponding to each other and respectively selected from the second crown sample group and the second abutment tooth sample group.

14. The confirming method according to claim 13, wherein
in the confirming step, an image or image data obtained by imaging an appearance of the crown sample is used, the image or image data being obtained before and after the abutment tooth portion of the abutment tooth sample is inserted into the open cavity of the crown sample.
